(19) United States
(12) Patent Application Publication
(10) Pub. No.: US 2010/0296754 A1
(43) Pub. Date: Nov. 25, 2010

(54) AUXILIARY GRIP FOR HEAVY DUTY BAGS

(76) Inventor: Manuel Chiu, Oakville (CA)

Correspondence Address: OGILVY RENAULT LLP, 1, Place Ville Marie, SUITE 2500, MONTREAL, QC, H3B 1R1, CA

(21) Appl. No.: 12/471,423

(22) Filed: May 25, 2009

(51) Int. Cl. B65D 33/08; B65D 33/06; B31B 1/14

(52) U.S. Cl. 383/10; 383/16; 493/227

(57) ABSTRACT

A heavy duty industrial plastic bag has a main handle at one end of the bag and is provided with an upper corner section that is used to create a spout to pour the contents of the bag therefrom. The invention provides for ease of pouring the contents from the bag through the spout by providing, at the lower portion of the side edge opposite the main handle and the spout corner section, an auxiliary handle or grip section. After the spout in the spout in the corner section has been formed the user can lift the bag via the main handle with one hand and then grasp the auxiliary grip with the other or free hand, thereafter easily tilting the bag to facilitate the pouring of the contents from the bag through the spout.

### TECHNICAL FIELD

The invention relates in general to heavy duty plastic bags used for the transport of, for example, particulate material, and more specifically to an auxiliary grip or handle for such bags to facilitate the pouring or emptying of the contents from the bag.

### BACKGROUND ART

Heavy duty plastic bags are widely used to package products such as fertilizers, water conditioning salts, pet food, lawn and garden soils, potting soil, limestone, cedar mulch, marble chips and other similar products. These bags, when filled, can be very heavy and bulky. They can easily weigh 20 kg or more. To empty the bags, past practice has been to cut the bag open at one end, either transversely across the bag end or diagonally across a corner, with a utility knife or scissors, and to lift the bag via the handle, if one was provided, with one hand while placing the other hand at the bottom of the bag. While lifting the bag using both hands the user would then tilt the bag to pour the contents therefrom. In the past, one Improvement has been to provide a tear-away corner section by way of a perforated tear line diagonally across the corner thus eliminating the necessity of using a cutting tool to gain access to the bag interior. Typical easy-opening tear-away or cut-away features are shown in U.S. Pat. No. 5,593,229 (Warr); U.S. Pat. No. 5,482,376 (Mosely et al) ; U.S. Pat. No. 5,636,925 (Smiley); and U.S. Pat. No. 6,402,379 (Albright). None of these patents addresses the problems in actually lifting a heavy, flexible plastic bag filled with pourable material and lifting and tilting the bag for emptying the contents. However, it is known to do this with rigid cans such as shown in U.S. Pat. Nos. 4,911,562, 4,928,860 and D504616, wherein the containers are injection molded.

The plastic bag is manufactured by extruding polyolefin through a circular die, typically used for blown film, or a flat die, typically used for a cast film, into a sheet or tubular plastic film. It can be a single layer or a multiple layer film.

The plastic bag can be constructed using a single type or a combination of polyolefins such as low density polyethylene, linear low density polyethylene, high density polyethylene, polypropylene, rubber modified high density polyethylene, ethyl vinyl alcohol, nylon or other appropriate polyolefin. The typical thickness of the film material ranges from 3 mils to 10 mils.

The tubular film typically has a front wall, a back wall, and two edges. If the extrusion process is in a sheeting style then the Rim must be folded over and heat sealed into a tubular stock. The tubular film is then cut into the desired bag lengths. One end of a bag length is then transversely heat sealed, leaving one open end for filling purposes. The transverse heat seat is typically about ⅜″ away from the end of the film, leaving a skirt area for the attachment of an external rigid or main handle.

Another embodiment of the bag will have two transverse heat seals, one about ⅜″ away and the other about 3″ away from the same end of the film. The area between the heat seals forms a handle area where a pre-cut patch of film up to 12 mil thick is applied. Thereafter the film and patch are die cut, forming a patch handle for the bag.

The easy-open tear-away corner feature is documented in the prior art patents previously mentioned. That feature is a combination of a slit at the top of the bag, extending to just above the transverse seal, and a perforated line, forming the tear line, through both the front and the back wail, extending to the adjacent edge of the bag. The perforated line is usually at a top corner of the bag. Once it has been torn away there is an open corner which forms the pouring spout for the bag. The perforated line can be in various shapes: an arcuate shape (U.S. Pat. No. 5,482,376); an arcuate transition shape (U.S. Pat. No. 6,402,379); or simply a diagonal line forming a triangle at the corner of the bag. In all cases, the material at the corner is meant to be tom completely away along the perforated line, leaving the open corner as the pouring spout.

The difficulty with the easy open feature bag is in tilting the filled bag easily and pouring out the contents. The filled bag is lifted up via the main handle with one hand; the free hand then struggles to find a portion of the bag to grab onto to tilt the bag empty the contents therefrom from the corner spout opening.

### SUMMARY OF THE INVENTION

It is a feature of the present invention to provide a plastic bag of the type adapted to pour its content from a corner spout with the ability to be easily gripped and tilted to pour the bag contents from the bag.

According to the above feature, from a broad aspect, the present invention provides a heavy duty plastic bag for pourable material. The bag comprises a front wall and a rear wall with the walls defining sealed opposed side edges. A seal provided at one end of the bag and extends transversely from the opposed side edges. A main carrying handle is provided at this one end of the bag adjacent the transverse seal and located generally centrally of the bag. A corner section adjacent the main carrying handle is adapted to form a pouring spout between the one end of the bag and one of the side edges. An auxiliary grip section adjacent is provided adjacent the other of the side edges diametrically opposite the corner section below about mid-length of the bag. The auxiliary grip section is sealed from the interior of the bag and facilitates the lifting, tilting and emptying of the bag.

According to a further broad aspect of the present invention there is provided a method of forming a heavy-duty plastic bag for pourable material. The method comprises the steps of providing a plastic bag having sealed opposed side edges, a sealed top edge with a main carrying handle secured thereto. The bag has a corner section adjacent the main carrying handle which is adapted to form a pouring spout between the one of the opposed side edges and the top edge. An auxiliary grip is formed adjacent the other of the side edges below about mid-length of the bag and diametrically opposed to the corner section, by heat sealing the front and rear walls together to define a grasping area.

The auxiliary grip or handle is an area that is sealed off from the Interior of the bag such that the contents of the bag are restricted therefrom. The auxiliary grip area is preferably formed by a heat seal, starting from the edge of the bag below mid-length thereof and projecting downwardly spaced from the side edge to terminate back at the side edge or downwardly at the bottom edge to define an auxiliary grip area along the opposed side edge. The auxiliary grip area can be die cut to provide a gripping portion, as for example by two half-moon shaped die cuts to be used as finger grips or handle hole to insert the hand. The invention will now be described in greater detail with reference to the drawings.

### BRIEF DESCRIPTION OF THE DRAWINGS

FIG. 1 is a front view of a plastic bag in accordance with the present invention, prior to filling;

FIG. 2 is a front view of the plastic bag after filling;

FIG. 3 is a side view of the filled bag;

FIG. 4 is a schematic representation of the manner in which the bag will be gripped and tilted for pouring; and

FIG. 5 is a front view of the plastic bag with a reinforced patch handle.

### DESCRIPTION OF THE PREFERRED EMBODIMENT

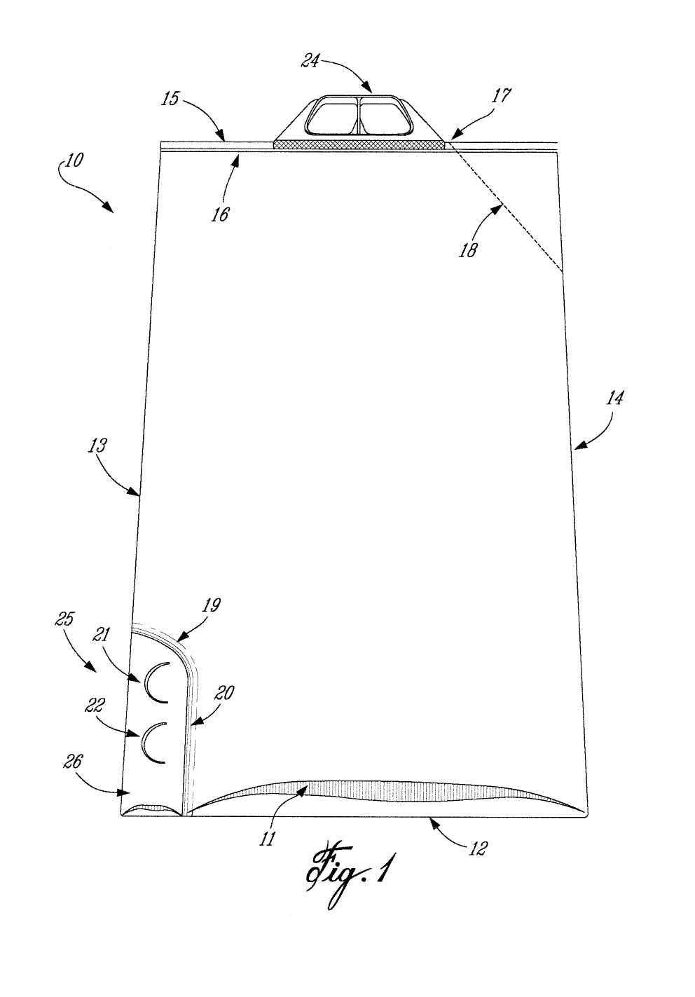

FIG. 1 illustrates a plastic bag 10 formed with an auxiliary grip or handle section in accordance with the present invention.

The plastic bag 10 is formed using a combination of polyolefin such as polyethylene or polypropylene having a thickness range from 3 mils to 10 mils. It can be of monolayer or multilayer construction. The bag 10 will have overlaying walls 11 and 12 defining side edges 13 and 14. The top end edge 15 is closed by way of a transverse heat seal 16 which extends from edge 13 to edge 14, approximately ⅜″ from the top edge 15, leaving a skirt area. An external rigid handle 24 can be attached in the center of the bag at the skirt area either by heat sealing or by ultrasonic sealing as is well known in the art.

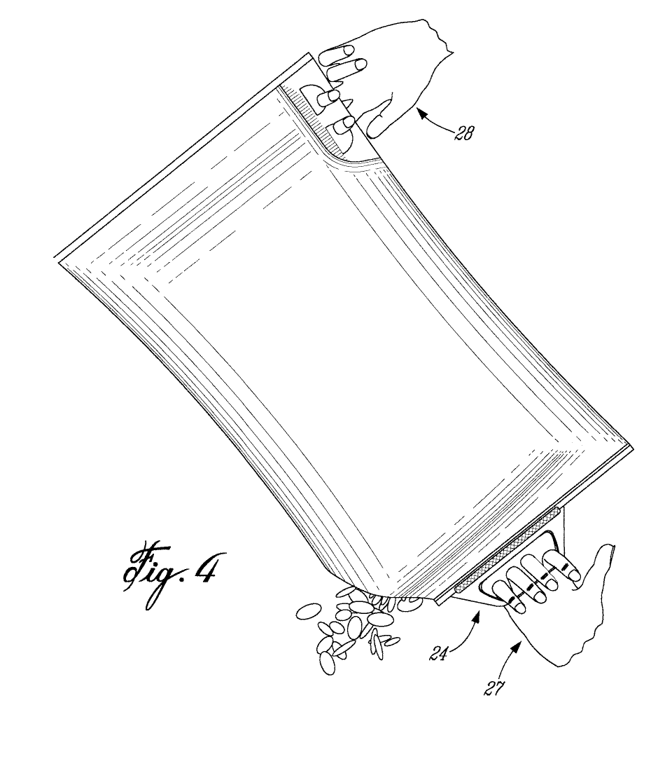

In one example of such plastic bag a tear-away spout section may be formed in a corner of the bag. In accordance with this known practice a slit 17 is provided above the transverse seal 16 and a line 18 of perforations extends diagonally (or arcuately) from the slit 17 at the transverse seal 16 downwardly toward the edge 14. In use, one will pull the skirt material adjacent the slit 17 in the direction of the line 18 of perforations. The perforations will give or separate, allowing the user to tear the corner section away from the bag along the line 18, so that the bag contents can be poured from the bag as shown in FIG. 4.

The auxiliary grip or handle section 25 of the present invention is found at the lower or bottom corner of the bag, diagonally opposite the line 18 of perforations. There it will be seen that an arcuate heat seal 19, of about a 2″ radius, extends inwards of the bag from the edge 13, starting about 6″ from the open end of the bag. A generally straight heat seal 20 extends from the lower end of the arcuate heat seal to the open end of the bag, generally parallel to the edge 13. The heat seal can be about ⅛″ to ¼″ wide. Preferably, two half-moon punch holes 21 and 22 will be die cut in the grip area to be used as finger grips.

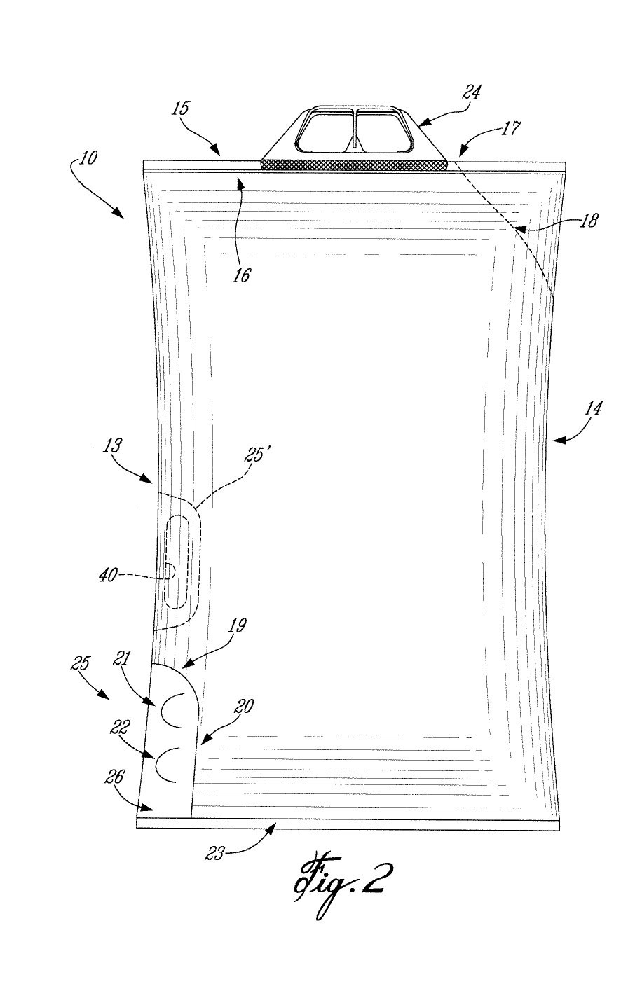

FIG. 2 shows the bag 10 after it has been filled with product and a transverse heat seal 23 has been applied across the lower end of the bag, sealing it completely. There will be no product within the gripping area 26 of the auxiliary handle as it is isolated from the bag interior and thus it will be readily accessible to the user, to be grasped and held as the bag is tilted and the contents poured therefrom.

FIG. 2 also illustrates in phantom lines another example of the auxiliary handle 25′. As thereinshown, the auxiliary grip 25′ is disposed adjacent the side edge 13 on the other side of the side edge having the dispensing spout and spaced above the bottom edge having the heat seal 23 and below mid-length of the bag. It may be provided with a handle hole 40 or slit finger holes.

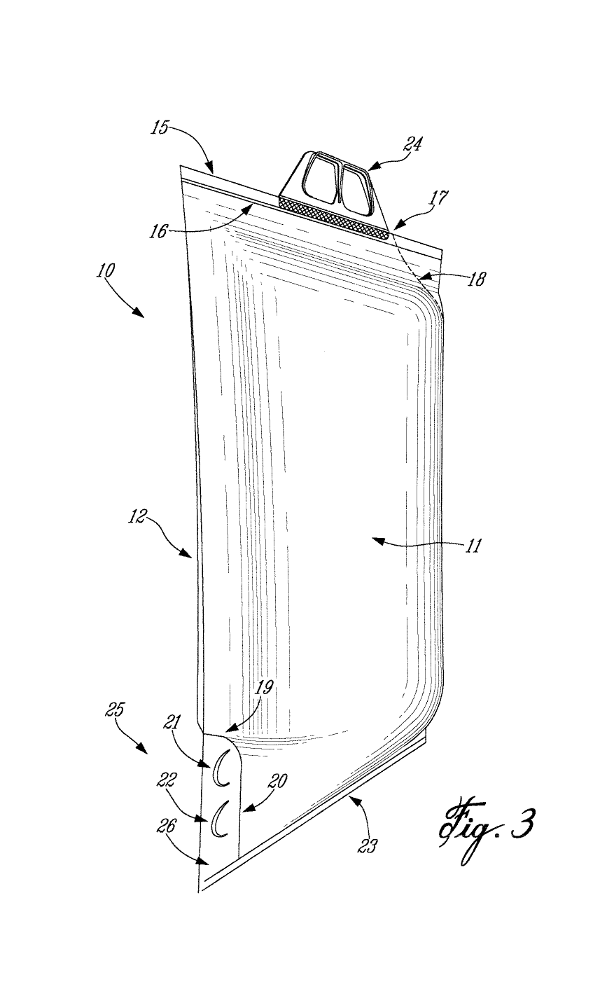

FIG. 3 is a perspective view of the filled bag illustrating how the gripping area 26 is very thin relative to the filled bag, being only the combined thickness of the front and rear walls of the bag in that area.

FIG. 4 Illustrates how the filled bag 10 is held by the user with one hand 27 holding the main handle 24 and the other hand 28 holding the auxiliary grip 25 by way of the holes 21, 22. The bag contents are shown leaving the bag through the pouring spout created when the tear-away corner section was removed from the bag.

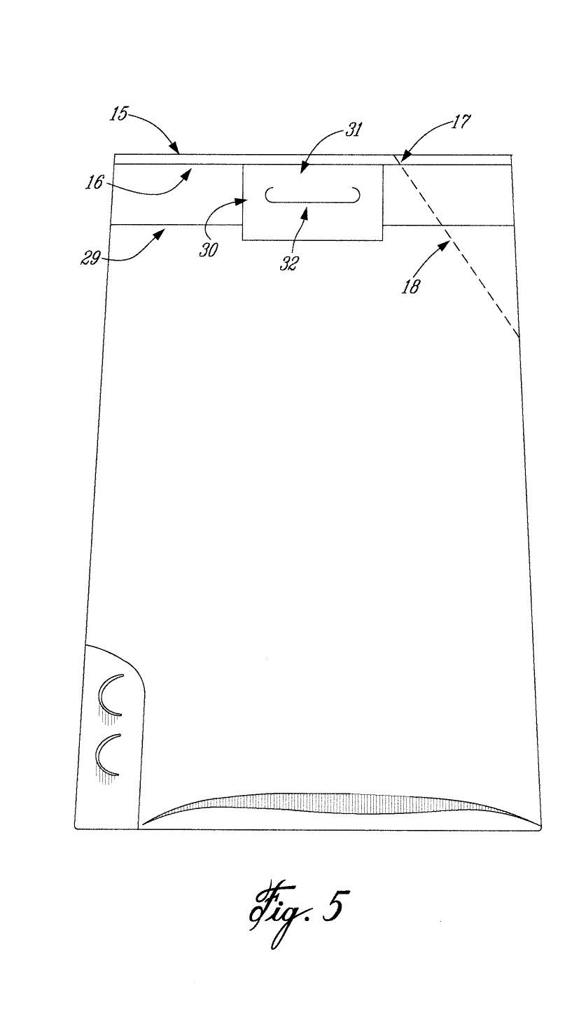

FIG. 5 shows the bag with a reinforced patch handle in place of the external handle 24 of the first embodiment. A patch 30 is heat sealed to the bag material below the heat seal 16, as at 31, and a second transverse heat seal 29 extends the width of the bag about 3″ from the top edge 15, passing over the patch 30 to help secure it to the bag side wall. The bag is thus reinforced by the patch. A die cut 32 through the material of the bag side walls and the patch forms the main carrying handle for the bag.

The drawings have illustrated a preferred form of the auxiliary grip or handle 25. As alternative embodiments a different shape of die cut hole could be provided in place of the half-moon shaped holes, or it would be possible to completely eliminate any die cut holes, leaving the user to grasp or squeeze the gripping area 26 itself. The gripping area 26 could also be reinforced with a patch film for additional strength. The patch film could be inserted into the tubular film prior to application of the heat seals 19, 20 or it could be applied externally using an adhesive. While the auxiliary grip or handle section of the present invention is intended primarily to aid the user when pouring contents from the bag it could also be used along with the main handle when carrying the bag from one location to another.

I claim:

1. A heavy duty plastic bag for pourable material comprising:
a front wall and a rear wall, said walls defining sealed opposed side edges;
a seal at one end of the bag, extending transversely from said opposed side edges;
a main carrying handle at said one end of the bag adjacent said transverse seal and located generally centrally of the bag;
a corner section adjacent said main carrying handle adapted to form a pouring spout between said one end of the bag and one of said side edges; and
an auxiliary grip section adjacent the other of said side edges diametrically opposite said corner section below about mid-length of said bag, said auxiliary grip section being sealed from the interior of the bag and facilitating the lifting, tilting and emptying of the bag.

2. The bag of claim 1 wherein a second seal extends transversely of said bag parallel to and spaced from said first defined seal, said main carrying handle being formed in aid bag between said first defined seal and said second seal.

3. The bag of claim 1 wherein said auxiliary grip section is defined by a seal extending from the other of said side edges inwardly and downwardly spaced and then back to said other of said side edges and in sealing engagement with said front and rear wall, and a gripping opening in said auxiliary grip section.

4. The bag of claim 1 wherein said auxiliary grip section is defined by an arcuate seal extending from the other of said side edges and a generally straight seal extending from an end of said arcuate seal to the other end of said bag, generally parallel to said other side edge, thereby defining a grasping area between said arcuate and generally straight seals and said other side edge of said bag.

5. The bag of claim 4 including a pair of half-moon shaped holes die cut in said grasping area of said auxiliary grip section to be used as finger grips.

6. The bag of claim 3 wherein said gripping opening is a hand hole opening.

7. The bag of claim 3 including a reinforcing patch positioned within said bag at the location of said auxiliary grip section.

8. The bag of claim 3 including a reinforcing patch adhesively adhered to said grasping area of said auxiliary grip section.

9. A method of forming a heavy duty plastic bag for pourable material comprising the steps of;
providing a plastic bag having sealed opposed side edges, a sealed top edge with a main carrying handle secured thereto, said bag having a corner section adjacent said main carrying handle adapted to form a pouring spout between said one of said opposed side edges and said top edge; and
forming an auxiliary grip adjacent the other of said side edges below about mid-length of the bag and diametrically opposed to said corner section, by heat sealing said front and rear walls together to define a grasping area.

10. The method of claim 9 including the step of die cutting said grasping area to create passage means for hand gripping.

11. The method of claim 10 wherein said passage means is constituted by one of a pair of half-moon shaped fingers receiving cut-outs and a hand hole cut-out.

12. The method of claim 9 wherein said grasping area is defined by forming a first arcuate heat seal extending inwardly and downwardly from the other of said side edges, and a second generally straight heat seal extending from said arcuate heat seal downwardly to the second end of said bag length.

13. The method of claim 12 including the step of filling the bag length from the second end thereof and then applying a heat seal transversely of the bag length inwardly of said second end, such heat seal closing said bag length and Isolating said auxiliary grip from the interior of the bag whereby no pourable material enters the auxiliary grip.

14. The method of claim 10 including the step of inserting a reinforcing patch between said front and rear waifs at said grasping area.

15. The method of claim 10 including the step of adhesively adhering a reinforcing patch to said grasping area after the creation thereof.

16. The method of claim 9 wherein there is further provided the steps of:
forming a line of perforations through said front and rear walls at said corner section of the bag, said line of perforations extending generally from said top edge downwardly to the adjacent one of said side edges, said line of perforations defining a tear-away corner section.
